(19) United States
(12) Patent Application Publication
(10) Pub. No.: US 2004/0179153 A1
(43) Pub. Date: Sep. 16, 2004

(54) Color filter with low reflection and liquid crystal display device having same

(76) Inventors: Sheng-Shiou Yeh, Miao-Li (TW); Jia-Pang Pang, Miao-Li (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/801,433

(22) Filed: Mar. 15, 2004

(30) Foreign Application Priority Data
Mar. 14, 2003 (TW) 92105715

(51) Int. Cl. G02F 1/1335

(52) U.S. Cl. 349/106

(57) ABSTRACT

A color filter (30) in accordance with the present invention includes a transparent substrate (34), a black matrix (33) and a color resin layer (32). The black matrix has an antireflection layer (332) and a light-shielding layer (331) successively formed on the transparent substrate. The antireflection layer includes a first antireflection film (3321) having a first index of refraction, and a second antireflection film (3322) having a different second index of refraction. The black matrix defines a plurality apertures arranged in an array, the apertures being filled with the color resin layer, the color resin layer covering the black matrix entirely.

### BACKGROUND OF THE INVENTION

1. Field of the Invention

The invention generally relates to color filters and associated liquid crystal displays (LCDs).

2. The Related Art

In general, a monochrome or color LCD has the advantages of thinness, light weight and low power consumption. For this reason, LCDs are widely used in various types of electronic equipment, from pocket calculators to large-scale office automation equipment.

Conventionally, a color LCD includes a color filter at a position opposite to a liquid crystal layer. The color filter has three kinds of color (red, green and blue—RGB) resins separated by a black matrix having a plurality of apertures, and the visibility of the LCD depends upon the characteristics of the black matrix of the color filter.

The basic structure of a color filter is shown in FIG. 4. The color filter 20 includes a transparent substrate 24 deposited with a black matrix 23 defining a plurality of apertures (not labeled) therein. RGB color resins 22 are filled in the apertures repeatedly and separately between the black matrix 23. The RGB color resins 22 filter light beams passing therethrough, thus producing RGB color light beams.

The black matrix 23 functions as a light-shielding mask to improve the contrast ratio of an LCD using the color filter 20. In particular, the black matrix 23 increases the OD (Optical Density, i.e. light-shielding ability) value and reduces the optical reflectivity on the top and bottom surfaces thereof. However, the black matrix 23 is conventionally made from metal whose optical reflectivity is too high, or is made from resin whose OD value is insufficient. Thus, color filters have been developed to solve the above-described problems.

Referring to FIG. 5, a color filter described in U.S. Pat. No. 6,285,424 issued on Sep. 4, 2001 is disclosed. The color filter 1 comprises a black matrix 9 ha formed on a transparent substrate 2. The black matrix 9 comprises first and second antireflection films 3, 4, and a metal screening film 5 formed one on top of the other in that order. The antireflection films 3, 4 are made of different kinds of metallic compounds having mutually different compositions. At least one of the films 3, 4, 5 contains chromium (Cr). In addition, RGB color resins are filled separately in apertures of the black matrix 9.

The multi-layer antireflection structure of the black matrix 9 can decrease the optical reflectivity on one surface thereof adjacent to the transparent substrate 2. However, the optical reflectivity on the other surface thereof that is opposite to the transparent substrate 2 remains large. That is, the optical reflectivity of the outer surface of the metal screening film 5 remains large. When the black matrix 9 is used in an LCD, back lighting is reflected excessively by the outer surface of the metal screening film 5 of the black matrix 9. This creates light interference which leads to decreased visibility of the LCD.

Therefore, a color filter with low reflectivity on both surfaces thereof and an LCD using the same is desired.

### SUMMARY OF THE INVENTION

An object of the present invention is to provide a color filter with low reflectivity on both of main surfaces thereof.

A color filter in accordance with the present invention comprises a transparent substrate, a black matrix and a color resins layer. The black matrix has an antireflection layer and a light-shielding layer successively formed on the transparent substrate. The antireflection layer comprises a first antireflection film having a first index of refraction, and a second antireflection film having a different second index of refraction. The black matrix defines a plurality apertures arranged in an array, the apertures being filled with the color resin layer, the color resin layer covering the black matrix entirely.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a schematic, cross-sectional view of part of an LCD device according to the present invention;

FIG. 2 is a schematic, cross-sectional view of part of a preferred first embodiment of a color filter used in the LCD device of FIG. 1;

FIG. 3 is a schematic, cross-sectional view of part of a preferred second embodiment of a color filter according to the present invention;

FIG. 4 is a schematic, cross-sectional view of part of a conventional color filter; and

FIG. 5 is a schematic, cross-sectional view of part of another conventional color filter.

### DESCRIPTION OF THE PREFERRED EMBODIMENTS

Referring to FIG. 1, an LCD device in accordance with the present invention includes a color filter 30 combined with an electrode substrate 37, thus forming a cavity therebetween filled with a liquid crystal layer 35 therein.

The color filter 30 includes a transparent substrate 34, and a black matrix 33 formed thereon. The black matrix 33 defines a plurality of apertures (not labeled), the apertures being filled with a color resin layer 32. In addition, an ITO (Indium Tin Oxide) layer 31 is formed on the color resin layer 32, and a TFT (Thin Film Transistor) layer 36 is formed on an inner surface (not labeled) of the electrode substrate 37.

Referring also to FIG. 2, the black matrix 33 has an anti-reflection layer 332 formed on the transparent substrate 34, and a light-shielding layer 333 formed on the antireflection layer 332. The antireflection layer 332 includes a first antireflection film 3321, and a second antireflection film 3322 formed on the first antireflection film 3321. The two antireflection films 3321, 3322 respectively have a first index of refraction and a different second index of refraction. For example, the first refraction index may be less than the second refraction index. In addition, the two antireflection films 3321, 3322 preferably have thicknesses in the ranges from 20 to 60 nm and from 20 to 100 nm respectively. Further, the two antireflection films 3321, 3322 are preferably made principally from chromium oxide (CrO_{X}, X denoting the ratio of the number of atoms of Cr to the number of atoms of O) and chromium nitride (CrN_{Y}, Y denoting the ratio of the number of atoms of Cr to the number of atoms of N) respectively. The light-shielding layer 333 is made principally from chromium, and has an index of refraction less than the second index of refraction of the second anti-reflection film 3322.

The color resin layer 32 includes three kinds of color resins, i.e. RGB (Red, Green, Blue) resins. Each three contiguous apertures of the black matrix 33 are filled with the RGB resins sequentially to form a pixel. In addition, one of the RGB resins covers the black matrix 33 entirely. That is, a resin part 321 selected from one of the RGB resins is filled in a corresponding aperture of the black matrix 33 and covers the adjacent part of the light-shielding layer 333. The resin part 321 also adjoins two other resins filled in two adjacent apertures of the black matrix 33, such that the black matrix 33 is entirely covered. Thus, a continuous, planar RGB resin layer is formed over an entirety of the transparent substrate 34 and the black matrix 33.

In operation, back light emitted by an illuminator (not shown) passes through the electrode substrate 37 and the TFT layer 36 of the LCD device, and enters the liquid crystal layer 35. The two layers 31, 36 are connected with an IC (Integrated circuit) device (not shown) to control rotation of liquid crystal molecules of the liquid crystal layer 35 therebetween, so as to control the passing or blocking of the back light. Most of the back light passes through the liquid crystal layer 35, is filtered by the color resin layer 32 of the color filter 30, and emits from an outer surface (not labeled) of the transparent substrate 34. A remainder of the back light passes through the liquid crystal layer 35, but is blocked by the black matrix 33.

It is known that optical reflectivity of the color resin layer 32 is lower than that of the light-shielding layer 333 made from chromium. Therefore the back light impinging on an outer surface of the light-shielding layer 333 of the black matrix 33 is mostly absorbed by the color resin layer 32 rather than reflected by the light-shielding layer 333. Thus the phenomenon of light interference is diminished. That is, the OD value of the black matrix 33, and the visibility of the LCD device are increased. In addition, the two antireflection films 3321, 3322 of the black matrix 33 can decrease optical reflectivity of external light. Therefore, the object of providing a color filter with low reflectivity on both surfaces thereof is attained. Similarly, an LCD device using the color filter to provide a high brightness contrast is attained.

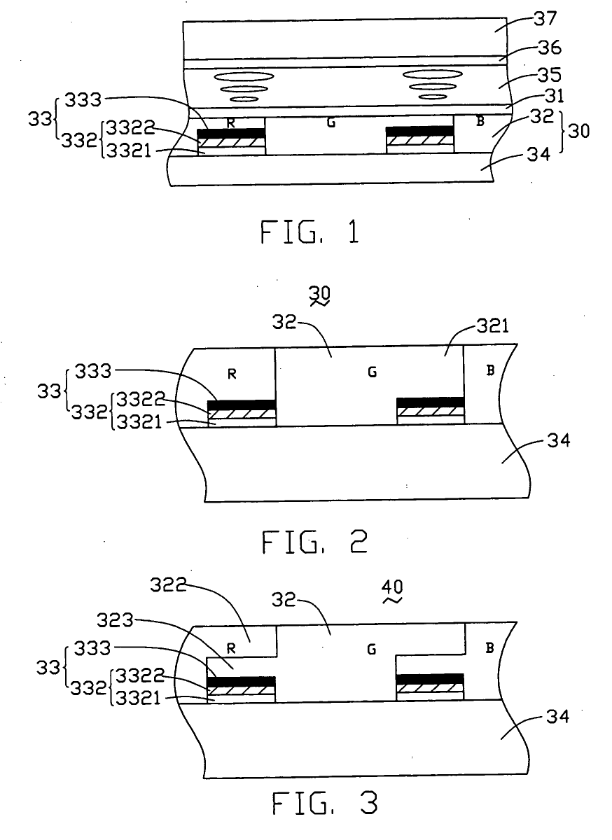

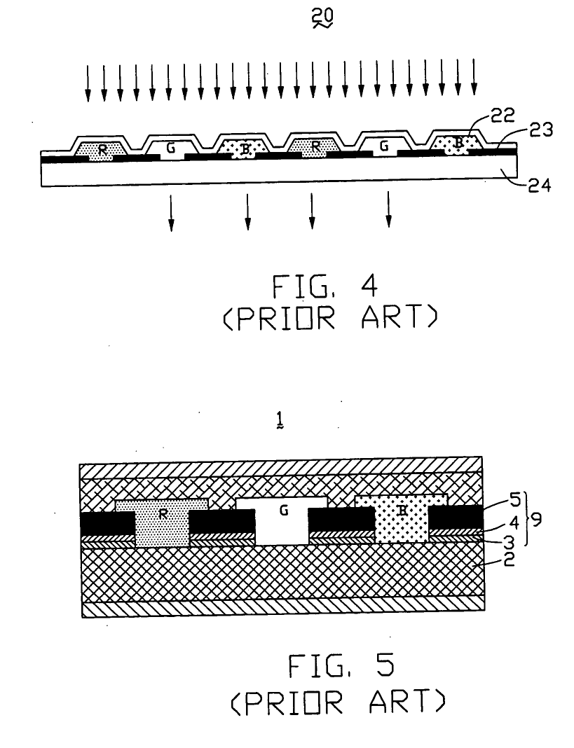

Referring to FIG. 3, a color filter according to an alternative embodiment of the present invention is shown. The color filter 40 has substantially the same structure as that of the color filter 30, except that the black matrix 33 is covered by two resin parts 322, 323 of adjacent RGB color resins. The two resin parts 322, 323 of RGB resins covering the black matrix 33 are lapped one on the other on the black matrix 43, and cooperatively cover an entirety of the black matrix 43.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A color filter comprising:
a transparent substrate;
a black matrix having an antireflection layer and a light-shielding layer successively formed on the transparent substrate, the antireflection layer comprises a first antireflection film having a first index of refraction, and a second antireflection film having a different second index of refraction; and
a color resin layer;
wherein the black matrix defines a plurality apertures arranged in an array, the apertures being filled with the color resin layer, the color resin layer covering the black matrix entirely.

2. The color filter as claimed in claim 1, wherein the antireflection layer comprises chromium oxide and chromium nitride, and the light-shielding layer comprises chromium.

3. The color filter as claimed in claim 1, wherein the color resin layer comprises RGB (red, green, blue) resins.

4. The color filter as claimed in claim 3, wherein the RGB resins fill each three contiguous apertures respectively.

5. The color filter as claimed in claim 4, wherein a respective portion of each of the RGB resins covers a corresponding portion of the black matrix.

6. The color filter as claimed in claim 4, wherein each two respective adjacent portions of each of the RGB resins cover a corresponding portion of the black matrix.

7. The color filter as claimed in claim 6, wherein said two respective adjacent portions are lapped on said corresponding portion of the black matrix.

8. The color filter as claimed in claim 6, wherein all said two respective adjacent portions cooperatively cover an entirety of the black matrix.

9. A liquid crystal display device comprising:
an electrode substrate; and
a color filter comprising:
a transparent substrate;
a black matrix formed on the transparent substrate; and
a color resin layer;
wherein the black matrix defines a plurality of apertures arranged in array, the apertures are filled with the color resin layer, the color resin layer covers the black matrix entirely, the electrode substrate in combination with the color filter forms a cavity therebetween, and the cavity is filled with a liquid crystal layer.

10. A color filter comprising:
a transparent substrate;
a black matrix applied upon said transparent substrate, and each unit of said black matrix having an anti-reflection layer and a light shielding layer;
a color resin layer further applied to said transparent substrate and covering said black matrix; wherein
said color resin comprises RGB (red, green and blue) resins, and each unit is completely vertically covered by at least one of said RGB resins.
